(19) United States
(12) Patent Application Publication
(10) Pub. No.: US 2020/0080865 A1
(43) Pub. Date: Mar. 12, 2020

(54) Providing Navigable Environment Plots

(71) Applicant: Jason Ervin, Austin, TX (US)

(72) Inventor: Jason Ervin, Austin, TX (US)

(21) Appl. No.: 16/563,900

(22) Filed: Sep. 8, 2019

Related U.S. Application Data
(60) Provisional application No. 62/728,823, filed on Sep. 9, 2018.

(51) Int. Cl. G01C 21/36; G06F 3/14; H04W 4/024; H04W 4/20; H04W 4/33; G01C 21/20; G06F 16/29

(52) U.S. Cl. CPC G01C 21/3667; G06F 3/14; H04W 4/024; G06F 16/29; H04W 4/33; G01C 21/206; H04W 4/20

(57) ABSTRACT

Systems, apparatus, and methods provide navigable environment plots for locations or facilities, for example, buildings, offices, or the like, including multi-unit structures, office parks, or the like, and respective access point locations, such as doors, unit or suite locations, parking locations and/or wayfinding paths or routes to them. The systems and methods provide storing, editing, updating, deleting, etc. capabilities for the navigable environment maps and plots. The systems, apparatus, and methods may be used in logistics for delivery, pickup, or other services.

### CROSS-REFERENCE TO RELATED APPLICATIONS

This application claims the benefit of U.S. Provisional Application No. 62/728,823, filed Sep. 9, 2018.

### FIELD OF THE INVENTION

The invention is generally related to navigable environment maps and directions to locations, and, more particularly to apparatus, systems and methods for creating, editing, revising, updating, storing, and providing, navigable environment plots useful in conjunction with maps, which show access point and unit locations of buildings, such as multi-unit housing buildings, office buildings, etc., stairs, elevators, floor levels, and/or the like, and respective parking locations and doors, for use in logistics and navigation.

### BACKGROUND

Current systems and methods that provide navigable map-based directions for mobile devices, tablets, computers, or the like, such as Apple Maps, Bing Maps, and Google Maps, allow the display of maps and text-based directions in response to user requests for a specific address. Delivery applications, such as apps like Uber Eats or Postmates, running on mobile devices, allow delivery agents (or drivers) to see or view the pickup address, drop-off address, or GPS location of the buyer/requester, and display maps or text-based directions so the agent or driver may reach the respective addresses rapidly.

Some software, including Google Maps or Uber Eats driver app, also allow users to display their progress relative to a map in real-time. For example, if a mobile device is able to determine its geographic location, the device may download or otherwise access static, dynamic, or interactive maps corresponding with its location and then display the location on the map. Mobile devices typically calculate their position via an internal or external GPS component, or by calculating their position relative to one or more cell phone towers.

Relatively complete and accurate app maps are available for many parts of the world. Some maps may even show building shape and location; but map detail data or information stop here. Details are not included, such as the exact building number, apartment unit physical location within a building, office building suite number or location, access door information or location, or the like, are not provided, making it sometimes impossible or difficult to distinguish, for example, building number 5 from building number 9. Moreover, the lack of such detail may make pickup or delivery more time consuming than necessary, and therefore hinder efficiency. Finding an apartment number 333 in building 3, for example, may require searching, perhaps by driving around building 3 or on foot, versus the more easily found single-family house at 2333 Elm Street. The Google Maps or Uber Eats mobile maps may provide a guide to the front door or front gate of a multi-unit housing or office building, but their map databases may not contain detailed enough information as to floor level, unit or door location, leaving the user with the task of finding the exact building and unit or a specific office on their own. This typically requires physical activity to walk and search for the right floor level and building, unit, or office door, consuming time and adding inefficiency. Moreover, the database may be aware, via a satellite image, that a road is present inside a multi-unit complex, but the building number, floor level, or locations of the apartment unit being sought may not be stored. Buildings, although sometimes represented on maps, such as Google Maps, the specific building numbers, apartment unit numbers, or office suite numbers and their locations may not be shown.

Current solutions may present other disadvantages besides delivery agents or drivers unnecessarily spending time by driving around internal apartment complex roads to search for the exact building and then walking around the specific building, riding elevators, and/or climbing staircases until they find the particular unit door for pickup or delivery. For example, current personal navigation systems, such as provided by global positioning systems (GPS) service, may fail to work reliably inside buildings, and may not be well-suited for mapping buildings or offices, because these technologies generally require an unencumbered line-of-sight trajectory to multiple satellites to provide the necessary resolutions; reliable signals from these satellites may not be available inside a building.

Current solutions for private facility navigation based on facility map frameworks, such as hardcopy facility maps or PDFs, also may not be well-suited for advantageous navigation, because, typically, they may not be manually, automatically, or custom edited or adapted by the delivery agent or driver or by their portable or mobile device, according to their personal, company, long-term, or temporary preferences, or according to what may be learned by the agent or driver from their current logistics, classifications, and/or other contextual data or information, such as their calendar, time, and/or other activities, to predict more accurately the purpose of or exact location for any given pickup, delivery, drop off, or arrival.

For at least the foregoing reasons and for other reasons described below, which should be understood by those skilled in the art upon reading and understanding this specification, there is a need for improved systems and methods for locations, such as building or office exteriors, access points or doors, loading docks, and/or the like, and their interior units or suites, floor levels, staircases, elevators, and/or interior doors.

### SUMMARY

In accordance with embodiments of the invention, systems and methods may be provided on or to a portable electronic device(s) for creating, editing, revising, updating, storing, deleting, and/or providing navigable environment plots, showing access point (e.g., door, loading dock, freight elevator, staircase, etc.) location(s) and/or waypath(s) to multi-unit housing, apartments, buildings, offices, office parks, and/or the like, and/or respective parking, door, and/or other locations for use in logistics and navigation. Such plots may be displayed as an overlay(s) on maps or map tiles.

These embodiments may provide or respond to location, and/or building site requests from portable electronic devices, such as mobile devices, drones, or other devices and may be used to store and aggregate building numbers, floors, and access point locations. These embodiments may provide detailed data and information, such as navigable environment routes, directions, and/or other requested site, location, and/or ways, tracks, paths, etc. data and information (all referred to herein as a “plot,” “plots,” “plotted data,” “plotted information,” “plotting data,” or “plotting information”), which, in certain of these embodiments, may be overlaid on, applied to, superimposed over, used to extend, used to update or used in conjunction with, or to correct maps, routes, directions, etc. These plots may be used to determine specific locations or destinations of or in buildings and their accompanying unit or access points, and to optimize or suggest directions for use in response to current or subsequent location requests, such as for pickup or delivery of goods or to provide services. These plots may be created by a current or subsequent user to record data and information regarding a location, such as recording, entering, updating, deleting, or storing specific building or office locations or numbers, unit or suite numbers, access points, etc., as described herein. These embodiments may be used to speed up delivery and improve efficiency for the current user or for subsequent users, such as drivers, delivery agents, couriers, and/or other personnel, compared to situations in which no such plots have been created or are available.

In accordance with embodiments of the invention, systems, apparatus, and methods may be provided on or to a portable electronic device(s) for plotting building numbers, unit or suite door numbers, including elevation, directions, place(s) of entry to building(s), and/or photo(s) or video(s) thereof. These embodiments may be used by a user or mobile device (or drone, autonomous delivery vehicle, or the like) and include: (1) receiving, by a system, such as a server(s) (e.g., one or more servers that may be in a location or distributed on a network, which may include the Internet, having access to associated computer-readable storage media and a database(s)), a request for map information from a portable electronic device(s), such as a mobile device(s), of a user(s) as the device(s) reaches a location, the request for identifying the geographical location of the device(s) as it changes over time; (2) capturing and storing, by the system, the location and route traveled by the device(s) based on the changing geographical location(s) of the device(s); (3) transmitting, by the system, map information, building number(s), door number(s), access point(s), etc. data to the device(s) in response to the request for map and location information and based on the geographical locations associated with the request; (4) receiving, by the system, a request for location plotted data or directions from a starting location of the device(s), such as a parking lot location, access door, etc. of a building or office or a store, restaurant, furniture pickup location, retail outlet, or where the user of the portable electronic device is located, to an ending location, such as a specific unit, suite, or apartment location or door (note, the ending location may be a parking lot location, access door, etc. of a building or office or a store, restaurant, furniture drop off location, or retail outlet, as well or instead); and/or (5) transmitting, by the system, specific or estimated waypoint direction(s), path(s), route(s), (i.e., plotted data) between the starting and ending locations, to the device(s) based on a calculated or previously stored waypoint direction(s), route(s), path(s), and/or the building entrance where the user or a prior user entered and the ending location of the unit, suite, or apartment.

In accordance with embodiments of the invention, systems, apparatus, and methods may be provided on or to a portable electronic device(s) for plotting (or that provide plotted) building and unit or suite numbers at their respective specific locations and elevation levels based on the specific GPS service or approximate GPS service locations and elevation levels of the device(s) when a user(s) of the device(s) is at or near or approaching the building and unit or suite numbers. In certain embodiments the accuracy of the location may be at or within the range of (0.1) to 50 meters, depending on the accuracy of the particular satellite(s) or wireless network(s), such as WiFi, Bluetooth, or the like, or combination thereof, employed, or the cell tower triangulation or the like employed.

In accordance with embodiments of the invention, systems, apparatus, and methods may be provided on or to a portable electronic device(s) for providing one building number, and/or one unit number, and/or one suite number, and/or one apartment number, if an address includes the building number, unit number, suite number, or apartment number, to not overwhelm a user with unneeded building, unit, suite, or apartment numbers. The plotted building or unit or suite or apartment number location may include specific GPS coordinates or approximate GPS location and elevation level. In certain embodiments, the location accuracy may be the same as described above.

In accordance with embodiments of the invention, systems, apparatus, and methods may be provided on or to a portable electronic device(s) for providing feedback related to the trustworthiness, accuracy, or rating of specific building, unit, suite, or apartment numbers or building, unit, suite, or apartment locations data. These embodiments may include sending or transmitting a request for the plotted data from a user's, delivery agent's, or delivery company's device, such as a computer, mobile device, or drone. The request, for example, may be sent or transmitted to a computer or server (e.g., a remote computer(s), server(s), which may provide access to a non-distributed or distributed database(s)) that communicates with the device. The request may include the device's current, approximate, or relative location, such as its GPS location, and identifies the plotted data requested within a specified distance from or area near or around the device's current, approximate, or relative location. In response to the request, the computer(s) or server(s) may provide previously stored ratings of how reliable the building number or unit location data is, for example, how many times someone or something had confirmed the accuracy or reliability of the building or unit location. In addition or instead, the computer(s) or server(s) may provide to (or trigger in) the device an indication of the accuracy or reliability of the data, such as a displayed “star” rating, thumbs up/down, color (e.g., red for bad or green for good), shape or alpha changes, or the like, or provide to (or trigger) an audible sound, alarm, or the like in the device.

The requests and data discussed above may be communicated between the device and the computer(s) or server(s) via a network that includes a wireless portion(s), a wired portion(s), or a combination of both, for example, via the Internet or a cellular network, or a combination of both. The network may be a distributed network and the data may be stored in the computer(s) or server(s) in a single database or in distributed databases. In certain embodiments, the data may be stored on the device itself and synced directly or indirectly from or with the computer(s) or server(s).

In accordance with embodiments of the invention, a delivery person or driver may input the location data themselves into their computer or device, for example, their mobile device. This data may be synced to the computer(s) or server(s) described above, or it may not be synced, and the data stored only on their computer or device.

In accordance with embodiments of the invention, systems, apparatus, and methods may be provided on or to a portable electronic device(s) for changing plotted data and information. In these embodiments, a plurality of requests for plotted data and/or information may be removed or deleted, edited, modified, or changed from a plurality of devices (e.g., mobile devices, computers, servers, or the like), each request identifying the location of each device, where the plotted location data and information changes or has changed, over time, including data or information identifying units, suites, and/or building numbers, as described above. In these embodiments, new or updated plotted data and map information instead may be provided or transmitted in response to such request(s), because the locations received from the devices, such as mobile devices, drones, computers, or the like, do not correspond or no longer correspond with information identifying these or the surrounding locations. For example, data that exists or missing data needs to be sent to the system because something is wrong or missing, such as apartment numbers may have changed, doors moved, etc.

In accordance embodiments of the invention, plotted data and information may be displayed in a realistic way on the user's portable electronic device(s), such as in three (3D) and/or two (2D) dimensions, showing in elevation and/or bird's eye views all levels or floors or sides of a building or office in a rendering or outline form, and/or in holographic form, or a VR- or AR-type overlay of a rendering of the building or office. In certain embodiments, the plotted data and information may be presented, as just described, on a portable electronic device(s) as an overlay on a photograph, rendering, or a copied or displayed image of the building or office, which may have been provided in electronic or hardcopy form by an entity associated with the building or office or by others. The user of the device(s) may switch, such as, between the 2D or flat bird's eye-type view and the more realistic view (e.g., 3D). For example, the user may point the device's camera(s) and view what the camera images on the device's screen or on a screen connected or coupled to the device by wire or wirelessly (e.g., via Bluetooth or WiFi) and the plotted data and/or VR or AR location image information may appear as an overlay over the camera(s) image(s). The overlay may show a target, unit number, door outline, color coding, or some other identifying indicator(s) of where the specific door, unit, suite, building entrance, or the like is located on the physical building or office structure.

In accordance with embodiments of the invention, systems, apparatus, and methods may be provided on or to a portable electronic device(s) for acquiring, obtaining, plotting, or marking plotted building numbers, unit or suite door numbers, and/or including elevation, directions, photo(s) or video(s), place(s) of entry to a building, or the like. These embodiments may include code or encoded instructions stored in computer-readable storage media and executed by one or more processors on a portable electronic device(s) (e.g., a mobile device(s), drone(s) or computer(s)) or stored and executed by a system server(s) and an associated database(s) (both of which may be distributed) communicating with the device to provide or allow: (1) a user manually plotting on the device(s) data or information which may be for display as, or part of, a map overlay, for example, of the location of each apartment door, suite door, office door, building door, or the like on each floor, or in the whole building or structure, while being located in or near such apartment door, suite door, office door, building door, or the like on each floor, or at the building or structure; (2) receiving, by the device, other plotted data, which may be for display as, or part of, the map overlay information sent or transmitted from another device (e.g., a mobile device, drone, or computer) as the other device reaches or comes near the same location(s), the received plotted data identifying the geographical location of the other device as it changes or has changed over time; (3) storing, on storage media of the device, the location, GPS service coordinates, elevation, route traveled, or the like of or by the other device based on the changing geographical locations received from the other device; (4) and plotting new data or information on the device for each apartment door, suite door, office door, building door, or the like and calculating instead the location of other doors, suites, or units' GPS service locations, elevations, etc. data based on the distance between the other doors, suites, or units and based on the data or information received from the other device.

For example, a first user (e.g., a DoorDash® driver) may not have any plot data and plots an access point, such as door 333 when he or she delivers a first package to an address. This activity may confirm the location of the door. If another driver (e.g., a FedEx® driver) also delivers a package there to door 335, then the DoorDash® driver may now see a new apartment popup on his device's screen. Assuming that the FedEx® driver dropped off packages two doors down at door 335 from the DoorDash® driver, then the system might add another door 334 in between the two doors in some way, such as by using a temporary color or shape, to indicate that door 334 might be between doors 333 and 335. Another example may be that the DoorDash® driver arrives to make the delivery described above, and another system user happens to be at a building next door plotting that entire building. The DoorDash® driver may automatically see new plots for the other building (e.g., for apartment numbers) show up on his or her view as soon as the other system user plots them.

In any event, in these embodiments, a user may be manually plotting or automatically plotting the items described above, or be in the process of doing so, based on certain settings or choices the user makes while making the plots. For example, the user may plot apartments 100 and 110 and then the system plots 101-109 automatically (see discussion of “auto” plotting/calculating plots below). The system server may determine or calculate the new plots based on new data or information, or another user's device may determine or calculate the new plots based on the new data or information and sends or transmits the new plots to the first user's device or sends or transmits the new plots to the server, which then sends or transmits the new plots to the first user's device.

In accordance with embodiments of the invention, systems, apparatus, and methods are provided on or to a portable electronic device(s) for acquiring, obtaining, plotting, or marking plotted building numbers, unit or suite door numbers, including elevation, AR or VR data, place of entry to buildings, units, suites, etc. via “auto” (or automatic) plotting. These embodiments may include plotting entire floors of units, doors, suites, offices, or buildings based on a pattern, location, or numbering of other plotted data or about to be plotted data, for example, for an apartment door(s), suite doors, buildings, units, doors, suites, or other buildings having similar units, doors, suites, offices, etc., or other structures, as described below.

In accordance with embodiments of the invention, systems, apparatus, and methods are provided on or to a portable electronic device(s) for acquiring, obtaining, plotting, or marking plotted building numbers, unit or suite door numbers, including elevation, AR or VR data, and place of entry to buildings, units, or suites, based on GPS service locations and blueprints or other hardcopy, PDF, etc. or other electronic versions thereof of buildings or offices. The blueprints may be hard paper copies or soft electronic images or data. These embodiments may include manually or auto plotting entire floors of units, doors, buildings, suites, offices etc., based on a pattern, location, or numbering of other plotted buildings, units, or suites of similar buildings, units, suites, or offices.

In accordance with embodiments of the invention, systems, apparatus, and methods are provided on or to a portable electronic device(s) for acquiring, obtaining, plotting, or marking plotted building numbers, unit or suite door numbers, including elevation, AR or VR data, and place of entry to buildings, units, or suites, in real-time or near real-time (e.g., taking into account processing and/or communications or transmission times), at a location(s) from a plurality of devices (e.g., mobiles devices) that are located at or near the location(s), or that previously have been at or to the location(s). The plotted data may be received by a user, driver, agent, or delivery person's portable electronic device(s) (e.g. a mobile device, drone or computer) as they arrive or have arrived, or as they are on their way to the location(s), to provide the newest, latest, or most up to date plotted data or information.

In accordance with embodiments of the invention, systems, apparatus, and methods are provided on or to a portable electronic device(s) for using plotted data to estimate a more accurate or approximate delivery time or accurate cost, quote, or approximate cost, such as the cost of a delivery, such as by Uber or a taxi service (e.g., for mileage and time charges), based on previous paths traveled to a building, unit, or suite by other users. These embodiments may include providing data or information about how many steps are or would need to be traveled or number of floors climbed or taken on an elevator by a user, where the approximate cost or amount of time (or time charged) may be calculated on the user's portable electronic device(s), on a server, or on a computer of others having access to the plotted data. These embodiments may also include accessing an application programmable interface (API) or webservice to obtain the data or information described by customers of a plotting service. These customers may use their own app or map and just show our data overlaid or superimposed on top of it. For example, Uber may use their own mapping software or Lyft may use Google's mapping software, but overlay or superimpose the plotting service's data or information on their map. For privacy reasons, for example, so that others do not know what type of item is to be delivered, such as a TV from Best Buy or food from a particular restaurant, these customers may only use the plotted data or information from the plotting service starting only at the parking lot of the unit where the item is to be delivered. These embodiments may also show plotted data to determine the access point(s) for the type of item being delivered or being picked up based on the type of store, restaurant, warehouse, government building, etc. associated with a starting or ending address. These embodiments may be used to provide the most efficient plotted data waypath or required waypath (e.g., required by the building management at the pickup location or drop off location) suggested by the system for the user to take, which may include certain access points, such as a particular door(s), loading dock, service elevator, stairs, etc.

In accordance with embodiments of the invention, systems, apparatus, and methods are provided on or to a portable electronic device(s) (e.g., a mobile device or computer) for displaying or receiving, on the device, plotted building numbers, unit or suite door numbers, including elevation, and place of entry to buildings, units, or suites, by electronic communications, such as text or computer-generated voice commands, and may also include other information, such as about which staircases or elevator(s) to take to get to a particular location(s), for example, to turn left or right and go down a particular hallway, go up a staircase of ten steps, look for the fourth unit on the right, and find the second door within the unit, or the like.

In accordance with embodiments of the invention, systems, apparatus, and methods are provided on, to, or for a portable electronic device(s) (e.g., a mobile device or computer) for plotting or marking building numbers, unit or suite door numbers, floor number, including elevation, place of entry to buildings, units, or suites, by drawing or rendering a line of any shape or a particular shape on the device, having or presented with a program interface, graphical user interface (GUI), or text or voice interface (e.g., a user interface), whose code or encoded instructions may be stored in computer-readable storage media, and executed by one or more processors, on the device or stored, executed, and sent, communicated, or transmitted to the device by a system computer(s) or server(s) having an associated database(s) on a network that may include the Internet, all distributed or not. The user interface may have fields for entering a beginning number, an ending number, a count by number, or the like, to plot up or down building numbers, unit or suite door numbers, floor number, including elevation, place of entry to buildings, units, or suites. The device or the system computer or server may generate, on a display of the device, renderings and/or locations of the doors, units, and/or building plots and accompanying data or information, which may then be saved to the storage media on the device, synced with a plurality of other devices, and/or synced with the system computer or server.

In accordance with embodiments of the invention, systems, apparatus, and methods are provided on or to a portable electronic device(s) (e.g., a mobile device or computer) for plotting or marking a building number, building unit or suite door numbers, including elevation, places of entry to the building, its units, and/or suite doors on the device, where the plotting may be stored in storage media as a template(s) on the device, synced with one or more other devices (e.g., mobile devices, computers, and/or a system server, as described above). The template(s) may include specific data or information about a building, such as its number as building 1 with apartments numbered 101, 102, 103, etc. This specific data or information may be used to plot (or add to a plot) an additional or another building having similar or the same layout, structure, units, and/or floor levels, etc. (e.g., for a sibling building, given or having another number like building 2). The one or more other devices may generate the corresponding locations of doors, units, and/or building plots and accompanying data or information (e.g., apartments 201, 202, 203, etc.) based on the template(s).

### BRIEF DESCRIPTION OF THE DRAWINGS

FIG. 1 is a flow chart, in accordance with embodiments of the invention.

FIG. 2a-2b illustrates a diagram of a system, in accordance with embodiments of the invention.

FIG. 3 is a pictorial functional diagram of a system, in accordance with embodiments of the invention.

FIG. 4 illustrates a user accessing or trying to access and use the system of FIGS. 2a-2b with their mobile device through a network or the Cloud, in accordance with embodiments of the invention.

FIG. 5 is an exemplary table of route data, in accordance with an embodiment of the invention.

FIG. 5 is a model of plotted data and model of plotting data via a template, in accordance with embodiments of the invention.

FIG. 6 illustrates a simplified diagram of mobile app navigation with a user interface on a device, in accordance with embodiments of the invention.

FIG. 7 illustrates a simplified diagram of mobile app navigation with a user interface on a device, showing a 2D elevational or vertical view of a building, in accordance with embodiments of the invention.

FIG. 8 illustrates a simplified diagram of mobile app navigation, with a GUI on a device that may be used for delivery, in accordance with embodiments of the invention.

FIG. 9 illustrates a simplified diagram of a facility map displayed on a device with a user interface in a plot editor mode, in accordance with embodiments of the invention.

FIG. 10 illustrates two simplified diagrams of facility maps displayed on a device, with a user interface in a plot editor mode, in accordance with embodiments of the invention.

FIG. 11 illustrates a simplified diagram of a mobile app navigation, with a user interface for a device, in accordance with embodiments of the invention.

FIG. 12 illustrates a simplified diagram of a mobile app navigation, with a user interface, in accordance with an of the invention.

### DETAILED DESCRIPTION

This application claims the benefit of U.S. Provisional Application No. 62/728,823, filed Sep. 9, 2018, which is incorporated herein in its entirety.

In the following description, numerous details are set forth to provide an understanding of the present invention. However, it should be understood by those skilled in the art that the present invention may be practiced without these details, without some of these details, or with additional details, and that numerous variations or modifications from the described embodiments may be possible.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer, server, portable electronic device, or portions thereof. By way of illustration, both an application running on a server and the server may be a component. One or more components may reside within a process and/or thread of execution and a component may be localized on one computer or server, and/or be distributed between two or more computers or servers.

The word “exemplary” is used herein to mean serving as an example, instance, or illustration. Any aspect or design described herein as “exemplary” is not necessarily to be construed as preferred or advantageous over other aspects or designs.

Furthermore, the one or more versions may be implemented as a method, apparatus, or article of manufacture using standard programming and/or engineering techniques to produce software, firmware, hardware, or any combination thereof to control a computer to implement the disclosed versions. The term “article of manufacture” (or alternatively, “computer program product”) as used herein is intended to encompass a computer program accessible from any computer-readable device, carrier, or media. For example, computer readable media or storage media may include, but are not limited to, magnetic storage devices (e.g., hard disk, floppy disk, magnetic strips . . . ), optical disks (e.g., compact disk (CD), digital versatile disk (DVD), or the like), smart cards, flash or other memory devices (e.g., card, stick), or the like. Additionally, it should be appreciated that a carrier wave may be employed to carry computer-readable electronic data such as those used in transmitting and receiving data or information, electronic mail or in accessing a network such as the Internet or a local area network (LAN). Of course, those skilled in the art will recognize many modifications may be made to this configuration without departing from the scope of the disclosed versions.

Various versions will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various versions disclosed herein can be performed on electrical devices including devices that utilize touch screen or haptic display technologies, autonomous (like a drone or autonomous delivery vehicle), and/or mouse-and-keyboard type human to computer interfaces. Examples of such devices include drones, computers (desktop and mobile), mobile phones, smart phones, personal digital assistants (PDAs), and/or other electronic devices that employ wired or wireless technologies or a combination of both.

In accordance with the embodiments, systems, apparatus, articles of manufacture, and methods are provided for storing, predicting, providing, editing, updating, and deleting location of multi-unit structures, housing, buildings, offices, suites, parking, parking lots, parking spaces, multi-story parking structures descriptions, mappings or additions to mappings, such as overlays, plotting, respective access points, or the like or units therein (e.g., geographic road maps, facility floor plans, campus layouts, stacked vertical floor layouts, cross sections in elevation, parking facilities, or the like) for use in or by delivery or pickup services, emergency services, such as fire, police, ambulance, or the like. These embodiments may address or at least reduce some issues that may be present in prior art location mapping, access point mapping, waypoint finding, facility mapping, multiunit mapping, and/or pickup or delivery processes. These embodiments may guide users, individuals, groups, delivery personnel, agents, crews, or emergency services personnel based on current service status, prediction of service being, or to be, rendered, promptly and efficiently to where services, pickups, deliveries, emergency services (e.g., fire or police department), or the like are needed or are to be provided (e.g., for delivery personnel, repair technicians, EMTs, or the like, and/or for navigation or logistics, etc.).

The embodiments described herein may use prior delivery paths, delivery types, or map-related requests to provide possible navigation, parking suggestions, multi-unit mappings, access points (e.g., doors), or the like. By way of example only, these embodiments may store previous details, such as routes traveled by portable electronic devices, such as mobile devices. These routes may be received by the portable electronic device or a system or remote server or computer in connection with another device's or user's request for maps or plots. When a request for data or information is received by a system server or computer, based on a recognized location arrival of a portable electronic device, or by a device or user's request for a particular location, the system server or computer executes code or encoded instructions stored in computer-readable storage media associated with the system server or computer that selects stored details, location(s), route(s), etc., or portions thereof, that correspond with desired starting and ending points to get to or from the particular location. The system server or computer may also provide, for example, directions, where possible, relative to landmarks or other points of interest rather than, or in addition to, street names. The system computer or server may further use the route information to update its map database or object models.

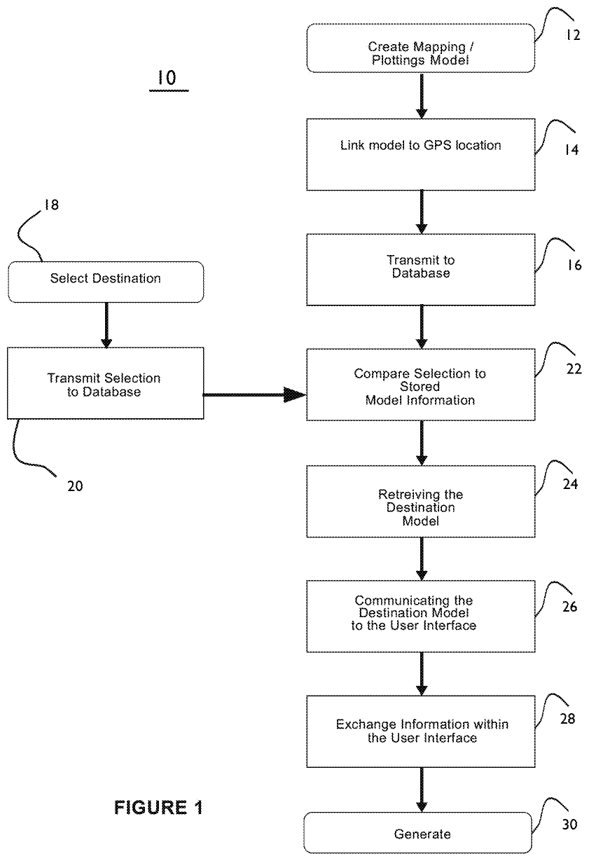

In accordance with embodiments of the invention, FIG. 1 illustrates a flowchart 10 for creating or generating and presenting a multi-unit mapping or “plotting.” Initially, a plotting data model (the “model”) of a geographic location is created 12. The plotting model is may be an interactive model for the user of a device, such as a portable electronic device. The plotting data model may be created by compiling historical or previous plots data (markers) and/or building new plots by adding new data, routes, access point markers, latitude and longitude points of previous portable electronic device(s) locations, descriptions, time stamps, image sources, such as, for example, photographs, film, video, or the like. An example of compiling may be combining or adding disparate data, such as combining or adding an old plot having apartment numbers, but no elevation data, with new more accurate elevation data. Those skilled in the art should appreciate that the geographic location data or information may have a variety of other kinds or types of geographic data or information besides just location data or information. For example, elevation and directional information may be additional geographic data.

Any geographic location may be divided, for example, into segments or units representing an intersection, a section of a street, a section of an avenue or a road, or any other part or portion of the geographic location. Exemplary geographic locations may be a commercial establishment or a non-commercial multi-unit establishment, such as a shopping center, apartment, office building, dorm, market, or any other location. The geographic location may also include an interior and an exterior of the geographic location, such as the interior and exterior of a building. The model may be created by a user or operator of the a portable electronic device using an application (e.g., a mobile application) provided by a third party or provided by their own or their own company's application, application interface or GUI, text or voice interface, or the like, code, encoded instructions, or software (e.g., a user application, user app, or user interface), which allows or provides communications and interfacing capability with a proprietary API not owned by the user, operator, third party, or their company. Examples of such user apps include Uber Eats driver app, United Parcel System (UPS) delivery person PDA, FedEx PDA. Alternatively, in certain embodiments, the user interface may be created, owned, or provided by the owner of the proprietary API and the model may be created by the owner of the proprietary API. In other alternative embodiments, the model may be created by a user or operator of a portable electronic device while not using (or bypassing) a proprietary API, instead being created in or by a system server or computer having the location data and information available from and/or created by the system server or computer and/or stored in associated databases or storage media of the system server or computer. In yet other embodiments, the system server or computer may create the model on its own or under the control of a remote operator not using the proprietary API, but rather the system's GUI and software instructions (code), which is then communicated or transmitted to the user or operator of the portable electronic device. In certain embodiments, the model may be created to be used by a user (e.g., a driver) or customer using the system on commercial or non-commercial bases, and/or by the combined efforts of the user, customer, and the remote operator.

The model may be created using any suitable device, such as a portable electronic device (e.g., a mobile device), computer, drone, or other device. The device may have a user interface, as described above, image or data capturing capability, such as a 180 degree digital camera, 360 degree digital camera, ordinary digital camera, film-based camera, phone, video camera, or any other suitable image or data capturing device that may be included therein or therewith, without limiting the scope of the present invention. The user, customer, or operator also may create or add to the model using systems drawing software, a device's GPS service, camera, map SKD, and/or any other of the device's features, which may be used to capture surrounding information or data.

Referring again to FIG. 1, as or when the model is being created, the model is linked to a geographic location 14, for example, using the GPS data obtained, and the linked model and geographic location may be transmitted to the aforementioned database(s) 16 (such as a database 20) stored in a system server or computer, or in or with any other computer/information processor of the system having associated data storage media. Many locations may have their geographic and other location data or information stored, as described. In some embodiments, the geographic location and other data and information may be stored on a portable electronic device. A user or another user may select, using a device (e.g., a portable electronic device, computer drone, or other device), a destination 18 (or a system server or computer (or an operator thereof) may select it) and transmit or communicate the selection to the database 20. The device itself may detect or determine a current or future pickup and/or delivery location(s) from data or information, and using code or encoded instructions, stored in computer-readable storage media of the device, the code or encoded instructions executed by one or more processors of the device for this purpose. For example, the device may use a “to do” list of the user stored in the device's computer-readable storage media, where the delivery will occur in the future, is ongoing, or may be based on a last known GPS location of the user. The device may automatically display the data or information of the location(s) for the user on a display screen of, or associated with, the device.

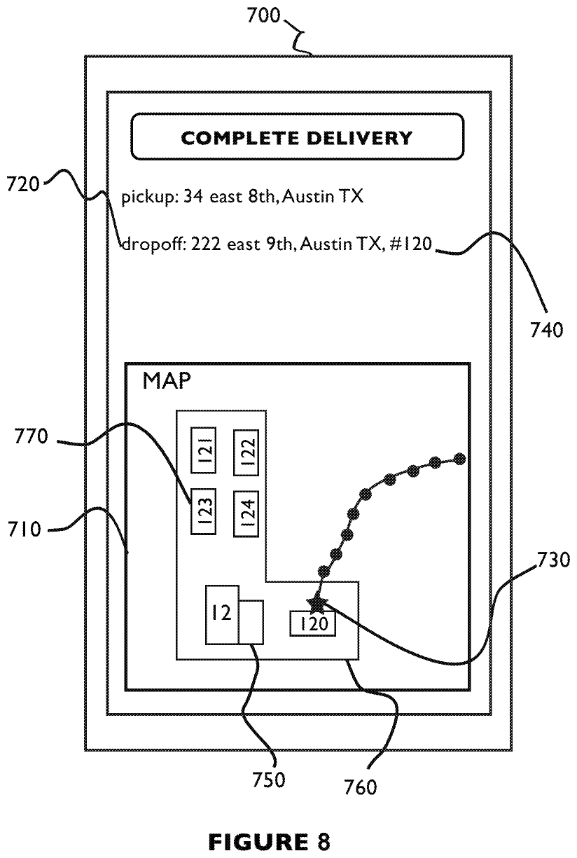

One or more processors of the system server or computer, or the other information processor, executes code or encoded instructions stored in associated computer-readable storage media that compares the user's or the system's selection to stored model information 22. Provided that the selected destination is available from the database, whether introduced thereto by the operator, the system server or computer, by other users, and/or any combination thereof, the system server or computer, or other information processor of the system executes code or encoded instructions that may retrieve a destination model 24 of the selected destination. The system server or computer executes code or encoded instructions that communicates or transmits 26, to a GUI, the destination model 24 (e.g., as described above, or to a user interface, such as those described below with respect to FIGS. 8-12 of the user's device. There also may be an exchange 28, with the user interface, of data or information. As a result of this exchange, additional specific data or images (e.g., landmarks), specific areas of locations, access points, parking facilities, businesses, and/or the like) may be generated 30 and will appear, or be available on the display of the user's device, and/or stored in storage media of the device.

In accordance with embodiments of the invention, the aforementioned user interfaces may provide a comprehensive display of a navigable environment, such as those described below with respect to FIGS. 8-12, on the screen or display of the user's device (e.g., a local environment, with directions, plotted data, and/or more data or information about a location or a destination). The navigable environment may include interactive 2D or 3D maps, interactive 2D or 3D models, AR/VR overlays, a user-selectable index, which may include a plurality of selectable destinations, and/or an interactive navigation interface for the user. The navigable environment may be created in response to the user's selection, the user device's automatic selection, the system operator's selection, or the system's automatic selection, as described above. The selection of a particular geographic location or destination from a geographic region may be made and displayed on an interactive rendered map, or geographic or other layout, for a navigation interface on the user's device, or may be input by the user (or by an operator of the system server or computer, or may be automatically loaded on the user's device or the system server or computer, as described above) using the interactive models, index, and/or the navigation interface itself. The user interface and its associated code or encoded instructions may be stored in computer-readable storage media (or memory) and executed on the user's device or on the system computer, server, or the like available to the user or an operator. The user may use the navigation interface, for example, to navigate and see their current location, destination(s), path(s) or route(s) to travel to the destination, view an image(s) of the destination(s), and/or other points of interest or landmarks along the way that help navigation.

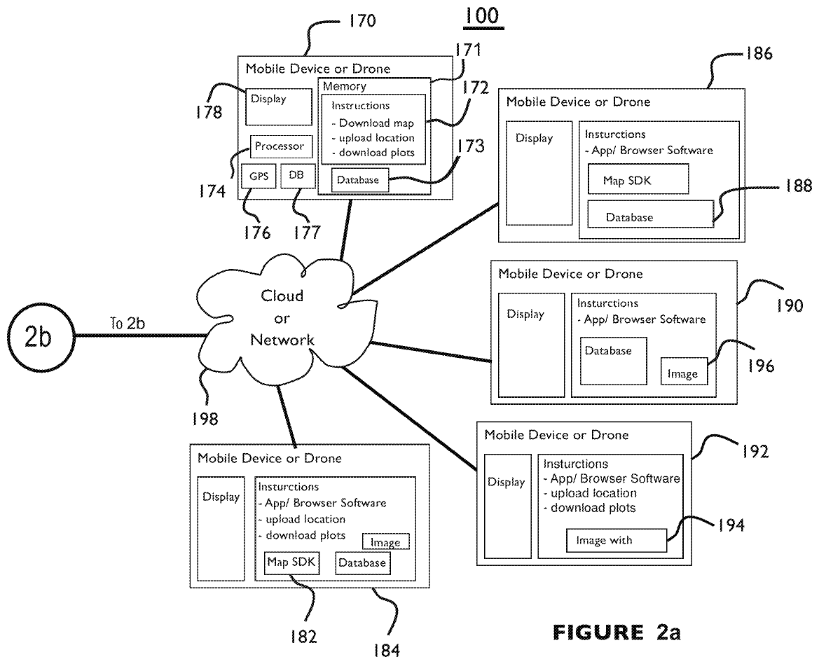

In accordance with embodiments of the invention, referring to FIGS. 2a and 2b, a system 100 includes a server 102 having one or more processors 105, storage media or memory 110, for storing code or instructions 115 executable by the one or more processors 105, and for storing data or information 120, such as: (1) GPS data for portable electronic devices like portable electronic device 160 (described below); (2) plotted data (described below), which may be stored in a plotted data database (DB) 125, including images/videos 135, routes 130 having routes database 140; (3) 3D/2D data 145, such as Scalable Vector Graphic (SVG) XML data; (4) data or information 150 related to units/offices/buildings/suites/apartment/access points, etc. of interest, as described herein; and (5) directions and location information of or for the portable electronic devices. In accordance with other embodiments of the invention, the foregoing components and functionality may also or instead be included in portable electronic devices like the portable electronic device 160, and/or in other portable electronic devices like mobile devices, mobile phones, tablets, computers, drones, etc., described below with respect to FIG. 2a. For example, mobile device or drone 170, besides including a display 178, may analogously include one or more processors 174, storage media (or memory) 171 storing encoded instructions or code 172 like the encoded instructions or code 115 and storing plotted database 173 like the database 125, and also include routes database 177 like the database 130 and GPS chips/capabilities 176, as further described below. Moreover, the mobile device may include sensors, such as those described below. The mobile device 160 may be just like, and have the same capabilities/hardware and software components/functionality, as the mobile device 170.

The system 100 addresses the needs of a user (e.g., a delivery or pickup driver), operator, customer, or the like (the “user”) by providing an, interactive, editable, or updateable (dynamic) rendered map, such as described above, or a non-editable, non-updateable (static) image (e.g., map tile(s)) rendered map, plan, or layout 152 for display on the user's portable electronic device 160 (e.g., a mobile device, drone, computer, tablet, or the like). A map tile may be a square or rectangular image (e.g., jpeg, png, or SVG drawn images), which typically does not have to be redrawn when dragged and dropped because they get stored or cached in the portable electronic device's or computer's volatile memory. The map 152, which may be such a dynamic rendered map or such a static rendered map, may be downloaded or transmitted to the user's device 160 wirelessly (not shown) or by wire from a nearby or remote system server or computer 102 or from another server or computer remote from the device 160 (not shown), which may be in the cloud and/or part of a network 198 (FIG. 2a), wherein the network may include the Internet. Or the map 152 may be displayed on the user's device 160 using a map app stored and running on the device 160 itself. For example, the map 152 may be from an app, such as Google Maps, Apple Maps, Waze®, or the like, that has been downloaded onto the portable electronic device 160. The map 152 may be created and/or integrated into or as part of an interactive display on a screen 161 of the user's device by a plot editor and selectable creation (or creator) features or tools 164 (text field), 166 (checkbox), and 168 (two buttons) (FIG. 2b), which will be described further below, also displayed on the user's device 160. The display of the plot editor and creation features, and their functionality, may be provided by encoded instructions or code stored in computer-readable storage media (or memory) (not shown) and executed in one or more processors (not shown) of the user's device 160 or in storage media (or memory) 110 and by one or more processors 105 of the server or computer 102, both of which may be distributed storage media (or memory) and distributed processors on a network. The map 152 also or instead may be displayed on a display (not shown) of the system or network server or computer 102 (or of another server or computer) nearby or remote from the user, as described above. The map 152 instead may be automatically created or edited without direct user input, as described above, on the user's device by using a location address (e.g., a pickup address, delivery address, or both) and encoded prediction instructions or code stored in computer-readable storage media and executed on the user's device (or on a system or network computer or server like the server 102 and communicated or transmitted to the device 160) provided with input data or information by onboard tracking, elevation, and accelerometer systems found on most user devices 170, 184, 186, 190, and 192 (FIG. 2a) like the device 160. Such addresses may be chosen by the user with a user interface in an app provided by the instructions like the instructions 115, but in the user's device, as described above, but a third party, who may use their own app on their own device, such as Uber Eats, may pass the addresses, which they received, for example, from a customer who ordered a delivery from them (e.g., restaurant food or groceries) to the proprietary API communicating with a server or computer (e.g., the server or computer 102) and associated databases, as discussed above. An algorithm (performing calculations) and artificial intelligence (AI) provided in the device 160 or the server or computer 102 may receive and use the user's vehicle or walking speed, elevation, etc. to generate the encoded prediction instructions, which may be presented to the user via plotted data on a map (or on a map tile(s)) displayed on a user interface and/or as plotted waypath instructions given by text, voice prompts, or other communications prompts from the user's device.

Detail-level maps 152, in certain embodiments, may be zoomed in or zoomed out, by the user or automatically, to higher or lower level or resolution, to provide more or less detailed geographic maps, respectively, or to change to other geographic maps, for example, to change the display to other locations or regions, or to show a different view (e.g., AR/VR) (not shown), and to provide a navigable environment map or list of navigation instructions or directions for easy navigation and/or overview. In one example, the plot editor and creator 164, 166, and 168 (hereinafter “editor” or “plot editor”) may define contents that may be added to and superimposed or overlaid on the map 152, such as building numbers 162, apartment door numbers, elevator locations, features or tools 164, 166, 168, and access point or entry (e.g., an apartment door) 154.

In FIG. 2b, an icon 162 is used to represent a building, for displaying the building's number. Once the number is added for the building, by typing in the text field 164, for example, typing the number 1, a “1” may be displayed on top of the building icon 162 just like for the access point or entry 154, there is a number over the door icon showing 123 for the door 123 for a unit. The checkbox 166 is used to make the current marker (e.g., building plot) a template to use later. Of the two buttons 168, one is for adding a new door and the other is for adding a new building. In FIG. 2b, the user of the device 160 has clicked the building button in 168, which has opened a form 165 to enter information about the building to add, in this case building 1. In accordance with other embodiments of the invention, a similar process may be used to keep track of units specifically, such as apartment units, as opposed to access points (e.g., unit doors).

Further, in regards to FIG. 2b, the portion 164 of the plot editor input form may be used for assigning/creating a building number as a template 166 or to clone or to replicate, and the button portion 168 of the plot editor may be used for creating a new door or a new building. The plot editor may define the access points 154, such as a door, define buildings 162, as well as parking locations or facilities or decks, paths, ratings (discussed below), etc. The user of the user's device or an operator of the system may map (i.e., add) the access points, paths, buildings, descriptions, and/or other location-related information or data (note shown) (i.e., the “plots”), such as GPS data, elevation, or the like, to the map 152. The plots may be subject to being moved, or changed within or on the map 152 when updated on the entire system 100 (FIGS. 2a and 2b), including on other user's or operator's devices connected or communicating in the system. For example, a database, such as Firebase, may be used and when a user or operator moves, edits, updates, or the like (i.e., changes), a plot, then all other users or operators of the system 100, including on any portable electronic devices being used, such as mobile devices 160 and mobile devices 170, 184, 186, 190, and 192, will see these changes at the same time or a few seconds later. Note that updates may be made to the plotted data based on previously or later created plotted data.

The plot data, information, images, route data, or the like transmitted to the server 102 of the system 100, via the Cloud or the network 198 (e.g., the Internet or including the Internet) (FIG. 2b), by any of the devices 160, 170, 184, 186, 190, or 192 (hereinafter “mobile devices”), may be received by the server 102 (or created and/or edited in the server 102) and stored into storage media 110, such as a short-term memory (e.g., volatile memory), processed by one or more processors 105 (in some instances, the data may be in “raw” form, i.e., not fully processed or only partially pre-processed by the mobile devices 160, 170, 184, 186, 190, & 192), and stored in a database internal to the server 102 or external to the server, such as in a database (or distributed database) associated and communicating with another networked server(s). It should be understood to those skilled in the art that such processing, storing, and databasing also or instead may be performed by or through cloud services providers like AWS or Azure, via the Internet or other connected network, for more distributed computer power.

In accordance with embodiments of the invention, the mobile devices 160, 170, 184, 186, 190, and 192 connected or communicating in the system 100 as described above, may perform operations, such as create, update, process, edit, store, delete, etc. the plots (that may work in conjunction with, or in addition to, map apps, as described herein) to the extent these devices have the onboard hardware (or hardware components) and software. The hardware (or hardware components) may include: (1) one or more processors; (2) one or more graphics processors (or integrated circuitry); (3) storage media (or memory, volatile and nonvolatile, whether localized or distributed, such as cache, RAM, flash, EEPROM, arrayed, or the like); (4) communications chip(s) (or integrated circuitry), for example, for WiFi, Bluetooth, or both); and (5) one or more sensors, which may work together to determine the location, acceleration, velocity, orientation, etc. of a user of these mobile devices. These sensors may include: (1) GPS chip(s) (or integrated circuitry); (2) a gyroscope, (e.g., a MEMS (Micro-Electro-Mechanical Systems) gyroscope); (3) an altimeter and/or barometer (or altimeter/barometer) for elevation determination; (4) an accelerometer (e.g., a MEMS accelerometer); and (5) a magnetometer. One or more of the foregoing hardware or hardware components may work with the mobile devices' cellular communications chips or circuitry for more accurate location determination, such as by using cell tower triangulation, and may be integrated as, with, or in one or more systems on chip (SoC), boards, or packages. Moreover, such cell tower triangulation may be employed for locating the mobile device(s) instead or in addition to GPS when GPS provides a weak or no signal for location. The software may include an operating system(s), code, apps, or encoded instructions 172 stored in the computer-readable storage media to be executed by the one or more processors and/or the one or more graphics processors, for performing these operations and for providing and storing the navigable environment maps and plots described herein. Some mobile devices may have the GPS capabilities 176, map SDK 182, and/or local volatile and/or non-volatile memory or databases 188. The onboard hardware and software components and sophistication may determine how much processing the mobile device may contribute before creating, storing, sending, editing, receiving, etc. the plots (hence, the data may be fully or only partially processed by the mobile device). Some drones on the market may only have minimal instruction processing power and minimal hardware because the available power is mainly required to keep the drone flying.

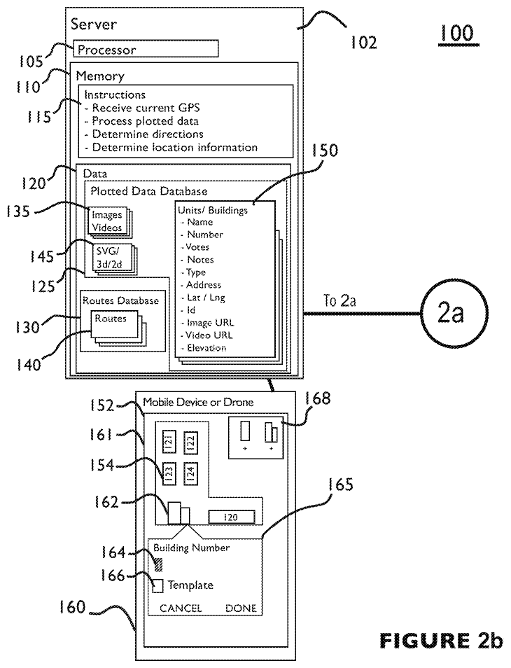

In accordance with embodiments of the invention, FIG. 3 illustrates how a user may interact in the system 100 via a GUI described above. The user may access a server like the server 102 via an app, or a website or a proprietary or third-party user interface, or another system, for example, through an API 200. It should be understood by those skilled in the art that an API like the API 200 may be part of code or encoded instructions, stored in storage media (or memory) like the memory 110, or as part of the instructions 115, accessed and executed by the one or more processors like the one or more processors 105 of a server like the server 102. Code or encoded instructions that run as part of the app or website, or proprietary or third party user interface, or the other system to create and/or modify the plotted data, as described herein, may interface with or first have to go through the API code like the API 200 in order to access the server like the server 102 to do so, as described above, or, in certain embodiments, may directly access the server by bypassing or not using the API (not shown in FIG. 3). These code or encoded instructions of the app may reside along with the API in storage media or memory, as a different set or lines of code or encoded instructions, accessed by the server. In other words, some APIs may be on separate systems on separate servers and some may not.

The API 200 allows clients 202, 204, which may be, for example, http-clients, web browsers, such as Google Chrome, Firefox. Microsoft Internet Explorer, Microsoft Edge, IOS Safari, Samsung or another Android Internet Browser, or the like. The clients 202, 204 may also be portable electronic devices, such as mobile devices or computers, or they may be software or an app that runs on the portable electronic devices.

Other users or operators that use portable electronic devices, such as mobile devices, laptops, tablets, or the like, or other servers, computers, or the like, may be authorized to use or be included in the system 100, for example, on a per-use cost, profit-sharing, subscription plan, one-time fee, or other basis as part of, inside, or within their own system for their users' or customers' benefit. Such other users or operators may use their own or other software systems, proprietary software applications, or mobile applications, which they may have to, or want to, communicate through the API 200. In this instance, for display in their own systems, the client 202 may access the API 200 to request plots for their current location, or for past or future pickup or delivery destinations or locations, by sending or transmitting the request to a server 206 (like the server 102), which may be a distributed server or computer. The request may first be sent or transmitted to another server or computer, which may also be distributed, that has, stores, and executes the code or encoded instructions of the API 200. Those skilled in the art should understand that the API 200 may be located on a separate server or computer (not shown) located in between the clients 202, 204 and the server or computer 206. The request will include authorization information, GPS data, an address, or other location data, and a format or type of response (e.g., XML, JSON, SOAP, etc.) desired 220 for receiving data back from the system 100. The request may be, as a nonlimiting example, a universal resource locator (URL) with header parameters, such as GET request, POST(create), DELETE, UPDATE(change), or the like, that includes some query string parameters, such as a number to limit the number of records returned by an API request, and with request body parameters, such as an address, latitude or longitude coordinates, or plot data, etc.

The system or part of the system running on the server 206, via the network or Cloud like the network or Cloud 198, may authorize such access and temporarily or permanently store the requested location, client's location, UID, UUID, account information, and time requested 230. The system server 206 may select appropriate plots data 232 based on the information received 230 and return or transmit the plots in the format and numbers (count/total) requested 234 ultimately to the client 202. If authorization is denied or an error occurs, instead of selecting plots, etc. 232, the user's client 202 is denied access, and an appropriate response instead may be sent or transmitted (e.g., a denial or error message) rather than no response. The client 202 that requested the plots may display, distribute, or use the information or data for its own purpose or needs, if it was authorized, or it may display information on an unsuccessful plot request in case of denied access, no authorization, or failure 222.

The other client 204 may send a create, update, or delete plots request 224 through the API 200. The system 206 may identify the request type and check for appropriate authorization 236. If access is denied or an error occurs, the system provides or transmits notification, as above. If access is authorized, the system 206 may perform the appropriate instruction or actions for the request type, prepare the data for response 238, and provide or transmit 240 the appropriate data to the client 204. The client 204 may perform its own encoded instructions for operations, according to the type of response it receives, and may provide a corresponding display 226 of its own (e.g., error, warning, plot, update, etc.).

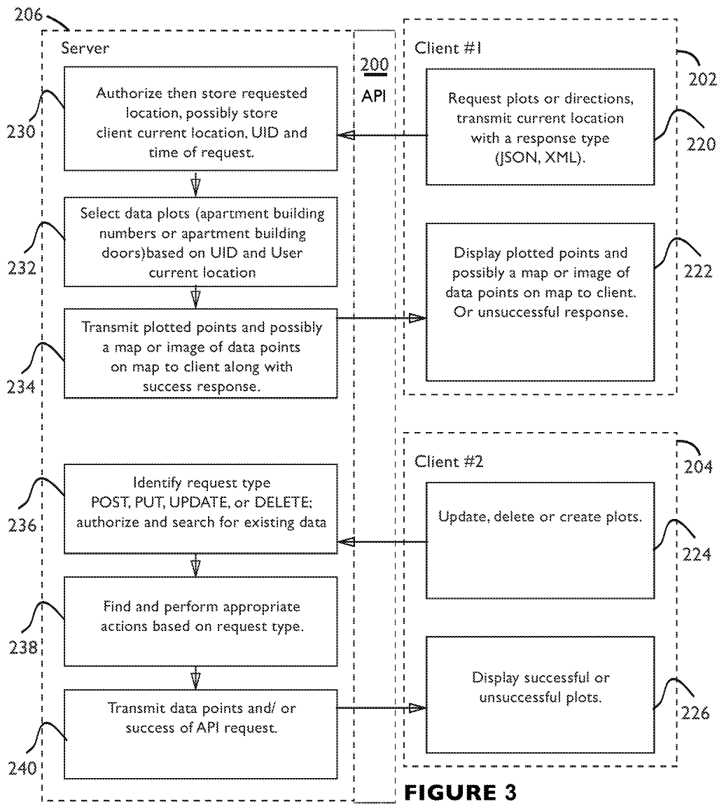

In accordance with embodiments of the invention, FIG. 4 illustrates a client user (or potential user) 340, who may be in the field, accessing or trying to access and use the system 100 with their mobile device 320 through a network or the Cloud 310 (e.g., including the Internet) like the network or Cloud 198. The user 340 may use the API 200 while at a destination 330 for which they are seeking plots, for example, to prepare a wayfinding path at or within the destination, such as a parking lot or facility to a particular access door, unit, suite, office, building, etc. In accordance with other embodiments of the invention, other client users (or potential users) 360 may access and use the system 100 directly installed or stored on their mobile device 350 to access plots for a destination(s) they are near or far away from, or to prepare a wayfinding path or route before arrival at this destination(s).

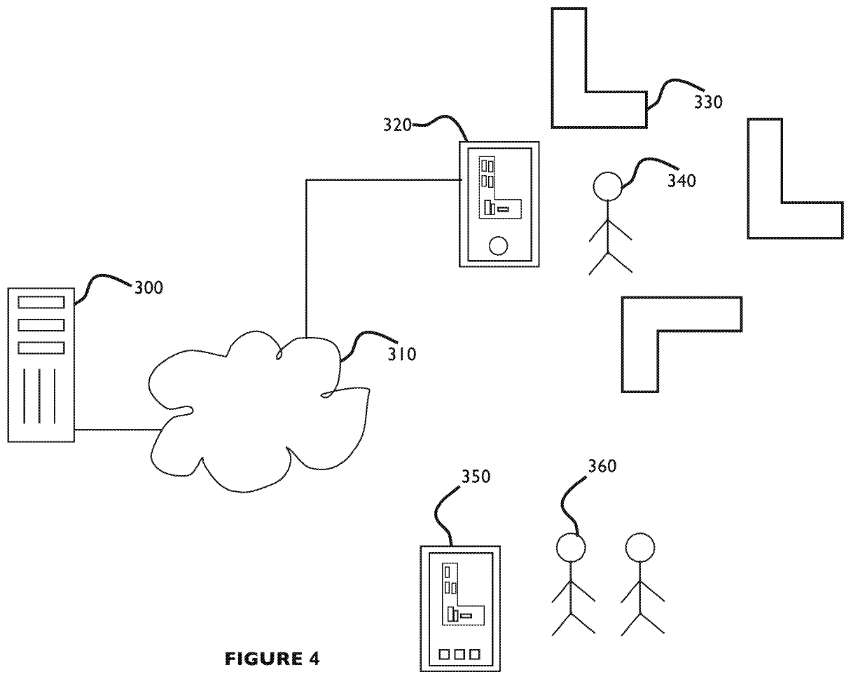

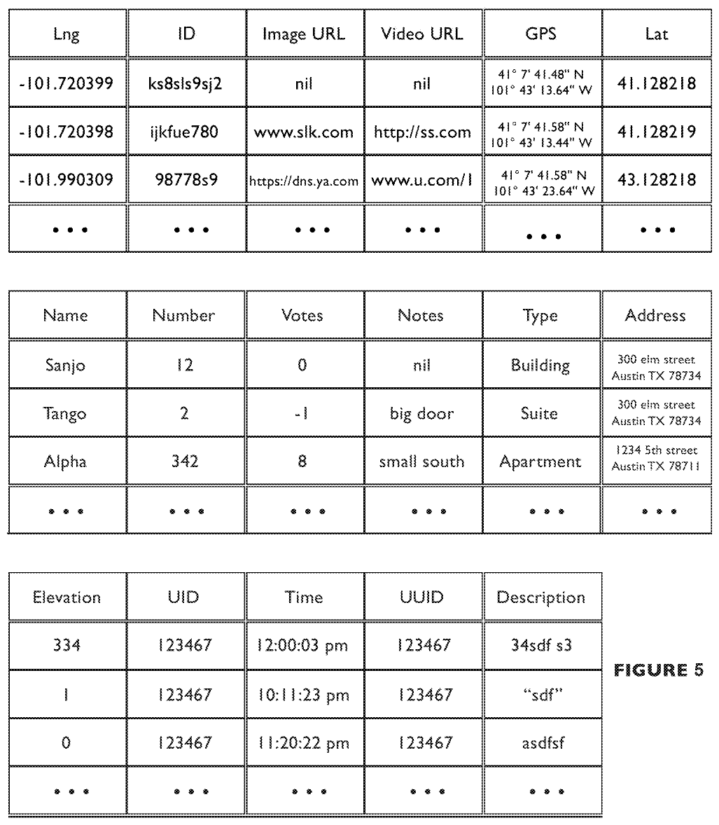

In accordance with embodiments of the invention, FIG. 5 illustrates just one example of possible stored plot data in one structured form. The data shown in FIG. 5 are merely illustrative and nonlimiting of the amount, type and/or sort of data that may be saved for a plot to give the user enough information to conduct the user's work or process, or to find the plot to be superimposed or overlaid on or within a map like the map 152 in a relatively quick and satisfying way. The data shown include: (1) latitude/longitude (LAT/LNG) coordinates; (2) reference ID of the record (database record); (3) Image(s) URL of the area (e.g., like Google Maps images of a house); (4) Video URL; (5) door/unit number (Number); (6) Votes (e.g., how accurate or social proof); (7) Notes about the location (e.g., where to leave packages, a gate code, or something the user wants to save; (8) Type of plot (e.g., Building, Suite, or Apartment); (9) Address of the location of interest (e.g., pickup/delivery address(es), if available or needed; (10) elevation or actual floor level of the unit or location of interest; (11) UUID (an identification of the portable electronic device, such as a mobile device) if one originally created the plot); and (12) a Description of the plot (e.g., AR/VR data). Such data may be used to create a wayfinding path or route to the destination of interest. The data may be stored in a system database (e.g., in the system 100), temporary Cloud storage, or the like (e.g., Redis, Memcached, etc.) for faster retrieval, or in a portable electronic device's short-term (cache) or long-term storage (SQL, MySQL, Core Data, etc.).

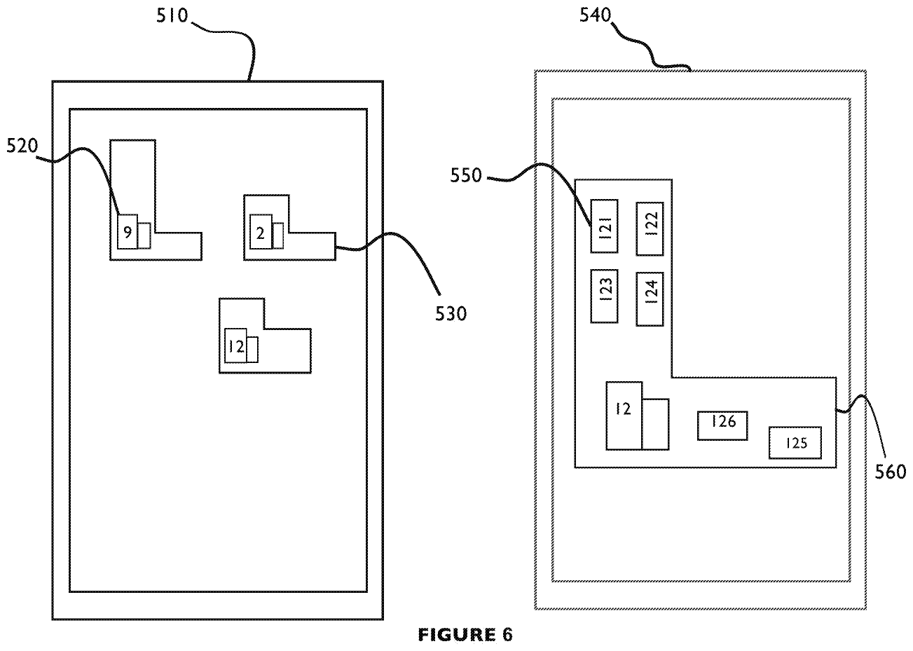

In accordance with embodiments of the invention, FIG. 6 illustrates a simplified diagram of mobile app navigation with a user interface on a device (e.g., a portable electronic device). FIG. 6 schematically shows that the user interface for the mobile device system may be divided between various user experiences. For example, the user interface may be configured with certain hardware and software features to optimize the user experiences while taking into account any limitations of the device's hardware and software capabilities. The left side of FIG. 6 illustrates a “zoomed-out” user interface 510, as one example in which the plots the user may see provide less information and less clutter on the screen of the device. Here, the user may see just physical shapes or outlines of buildings 530 and building numbers 520. The right side of FIG. 6 illustrates a “zoomed in” user interface 540 of the plots, which provides a more detailed view in which the user may see more information and detail about a multi-unit facility. For example, the user may view a building shape 560 and actual access points 550. The device and its software and hardware may allow the user to shift or switch between the zoomed-in and zoomed-out views. More details for each of these views will be provided below.

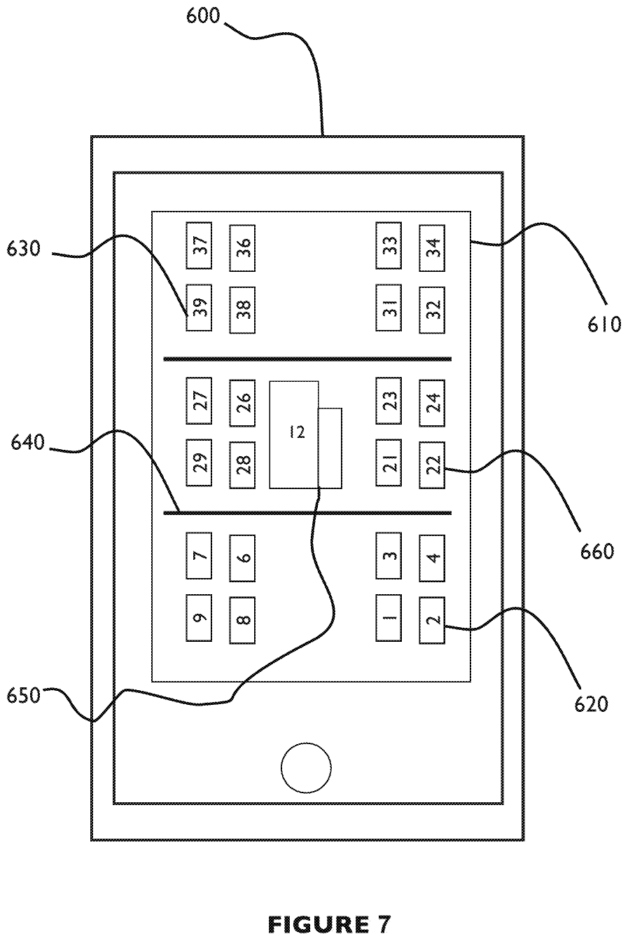

In accordance with embodiments of the invention, FIG. 7 illustrates a simplified diagram of mobile app navigation 600 with a user interface on a device. FIG. 7 shows a 2D elevational or vertical view of a building. Here, the user interface for the mobile device system may be divided between various user experiences, where the user interface may be configured with certain hardware and software features to optimize the user experiences while taking into account any limitations of the device's hardware and software capabilities. FIG. 7 illustrates the zoomed-in user interface 600, as one example, in which the plots the user may see provide details about a multi-unit facility. The user may see a building shape 610 in a vertical, street level-type, or elevational view, as opposed to a bird's eye or planar view. The user may see separate floor levels 640, access points on each level 620, 630, 660, and building numbers 650. More details for this type of user interface view will be provided below.

In accordance with embodiments of the invention, FIG. 8 illustrates a simplified diagram of mobile app navigation 700 with a user interface on a device that may be used for delivery. The user interface may display a set pickup address or location and set drop-off address or location 720, including a map 710 for navigation. The user interface for the portable electronic device system may be divided between various user experiences. The user interface may be configured with certain hardware and software features to optimize the user experiences while taking into account any limitations of the device's hardware and software capabilities. FIG. 8 illustrates the zoomed in user map 710, as one example, in which the plots the user may see provide details about a multi-unit facility. The user may see a building shape 760, including more detail about the multi-unit facility. The user may see a building number 750 and actual access points 770, where access points may be specific doors to interior offices, apartments, units, a building's main entrance, etc. The map 710 may be a static image or a live, dynamic, and/or interactive map provided by a third party, as described above, such as an IOS Map SDK or a Google Play Services Map SDK. The mobile application map user interface in FIG. 8 also displays plot data 730 that marks or identifies, for example, a wayfinding path from a current user location to an apartment 120 provided in the drop-off address or location 720. The mobile device may have the appropriate hardware, operating system and other software for the mobile app navigation user interface 700 to display the map 710 and automatically display the plot of the appropriate building, access point, wayfinding path directions, or the like that may be superimposed on or overlaid on the map 710. The map 710 may be obtained from data read from an existing mobile application running on the device, such as the Uber Eats mobile app, or from another mobile app, perhaps proprietary, running on or accessed by the device, or from a website accessed by the device, which also may provide or have provided the destination address 720 and a specific unit number 740 for the drop-off location or address 720. Alternatively, the user may input the addresses 720, which the map 710 would display.

In accordance with embodiments of the invention, and as another example, referring again to FIG. 8, a user of the device using a third-party app, website, or code or encoded instructions executed as part of a proprietary or third party user interface or system (e.g., Uber Eats, Postmates, Favor, Amazon, using an API), such as described with respect to FIG. 3, may be able to manually display the plots of wayfinding 730, building number 750, and access point 770 on the map 710. Here, manually means the user may alter settings to show or not show items on their app (e.g., whatever the Uber Eats app allows, or how Google maps can show a satellite view versus a regular map image view), as opposed to an automatic display that may show all data that an API like the API 200 provides. Further, the device's user interface may display the map 710 in a static image format, by requesting a static image(s), for example, by using the system and method described with respect to FIG. 3. As another example, the map 710 may be a static image provided by the Google Static Map API Cloud service, but the plots, such as the plots of wayfinding 730, building number 750, and access point 770, may be applied as a GIS overlapping layer on or over the static map.

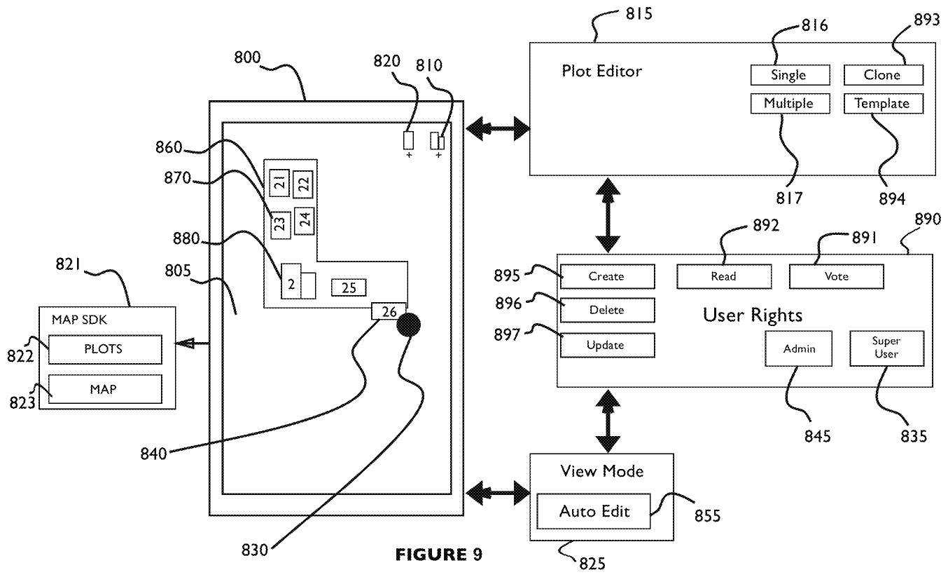

In accordance with embodiments of the invention, FIG. 9 illustrates a simplified diagram of a facility map 860 displayed on a portable electronic device (e.g., a mobile device) or computer 800 with a user interface in a plot editor mode. A plot editor 815 may define contents of a GIS maps layer 822 on a map layer 823 of a map sdk 821 (e.g., Google Maps, Apple Mapkit, etc.), including all plot data, such as building numbers 880, descriptions, names, access points 870, or the like and may be a stand-alone application or software run on the mobile device or computer 800 or may be displayed as a mode that can be switched to or on from a view mode on the mobile device or computer 800. Full user rights 890 may allow a user to read/view 892, create 895, edit and/or update 897, delete 896, vote 891, clone 893, or indicate the name/user handle of a single author 816 or multiple authors 817, and/or make a template 894 from one or multiple plots.

In one example, when in the plot editor mode, user interface elements 810, 820, such as for adding or removing plots or portions of plots, may be displayed to a user. The user interface, while in the plot editor mode, or possibly even in a view mode, may allow the user to update plots 840. The view mode, however, may appear similar to what the user sees when using an app like Google Maps, in certain aspects, in that the user typically cannot edit the plots, but may be able to make suggestions for changes to system operators or administrators through the user's portable electronic device. But, when the user may perform updates, for example, they may do so by dragging the plot(s) to a more accurate location on the map of a building, such as on map 805 and building 880, as schematically illustrated in FIG. 9. The user may do this, for example, by using their finger, mouse pointer, stylus, or any other means that a portable electronic device (e.g., a mobile device) or computer allows the user to move, reposition, drag and drop, or alter visual items (including, e.g., to alter, change, or update name, number, etc.) on the user interface. The filled circle corresponding to the reference numeral 830 may represent the user holding their finger down on the device screen while or after dragging such a visual item, like the building 880, to a new position.

In another example, automatic map editing may be available in an auto edit mode 855 while in a view mode 825, rather than in the plot editor mode. In this case, when a driver or delivery person arrives at a location and completes a delivery to a specific address, a system like the system 100 of FIGS. 2a, 2b, may automatically create 895, delete 896, or update 897 a plot, such as for the building number 880, wayfinding path, building unit number 860, and/or access point 870, etc., for the facility, building, or unit where the driver is currently located and completed the delivery or service. The auto edit mode 855 may do this without the system entering the plot editor mode and/or without requiring an administrator (Admin) 845 or super user 835 rights. Some of the user's rights, such as for repositioning 830 or updating 897 certain data of the plots, or for adding plots 895, may be given or accessed by other users without giving access to full user rights.

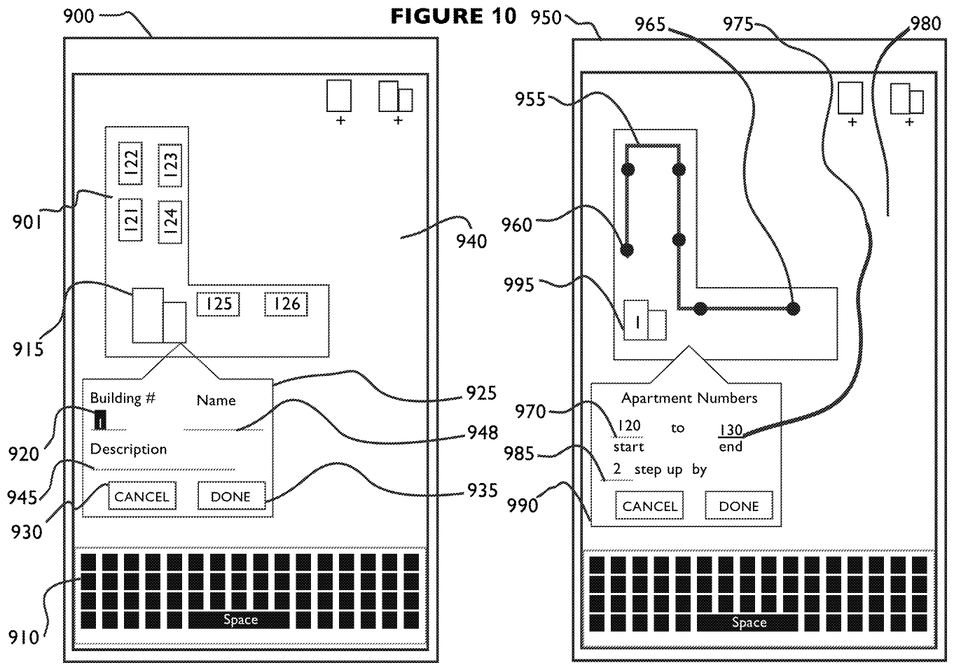

In accordance with embodiments of the invention, FIG. 10 illustrates two simplified diagrams 900, 950 of facility maps displayed on a portable electronic device (e.g., a mobile device), tablet, or computer, having a user interface, or part of a user interface like the plot editor mode 815, and where a user has some or a form of administrative privileges user rights. The diagram 900 on the left in FIG. 10 is of the facility map GIS layer being edited by an author or editor using a character input portion 910 GUI, such as a haptic or soft keyboard, or other character-generating human to computer interface or apparatus, in the plot editor mode, and illustrates the ability to add a building number 915 on a map or an image of a map 940 at a specific latitude/longitude and/or elevation. The author or editor may provide a description 945, name 948, and a number 920 with a plot creation form 925 having entry fields. The author or editor may save the edits with a done button 935 or may cancel the changes with a cancel button 930. In this instance, the plot creation form 925 may be a popup hover form. It should be understood by those skilled in the art, that any type of form may be used in addition or instead to author or edit the GIS plots. Elevation, GPS location, and/or other data may be collected for the purpose of editing, deleting, updating, etc. by the mobile device's onboard hardware and software or similarly, on other devices, such as drones, smart phones, PDA's, tablet devices or computers, or on any other portable electronic or mobile device that have such GPS hardware and software capabilities.

The diagram 950 on the right in FIG. 10 is of a facility map GIS layer being edited by the author or editor in the plot editor mode like the plot editor mode 815 and illustrates an ability to add/author multiple plots via a plot editor form 990 having entry fields. The author or editor may add access points or units, by drawing a line 955 and/or tapping multiple points 960, 965 in the GIS layer on a map or an image of a map 980, after establishing a start number 970 and an end number 975 of apartment entries or units and setting an increase in numbering step 985 (e.g. increase apartment numbers by 1, 2, or 4, etc.) of each plot. Upon saving the plot(s) form 990, 925, the data are sent to the system server like the system server 102 and associated system databases, and upon successfully saving them through the Cloud or a network (e.g., like the Cloud or network 198 that may include the Internet) to the servers and databases, the portable electronic device may update its display to show the successful results, and displays the plot(s) as a GIS layer or overlay on the map 901. If, as illustrated in this example, multiple plots 955, 960, 965 are successfully added/edited/authored through a multiple plot edit mode, as schematically shown in the diagram 950, the result may appear as an update to the facility map, displaying a revision that looks like map portion 901. Successfully adding/editing/authoring a single plot, as illustrated by the diagrams 900, 950 on the portable electronic device, via the single plot form 925, may result in an update to the display, for example, showing a plotted building 995.

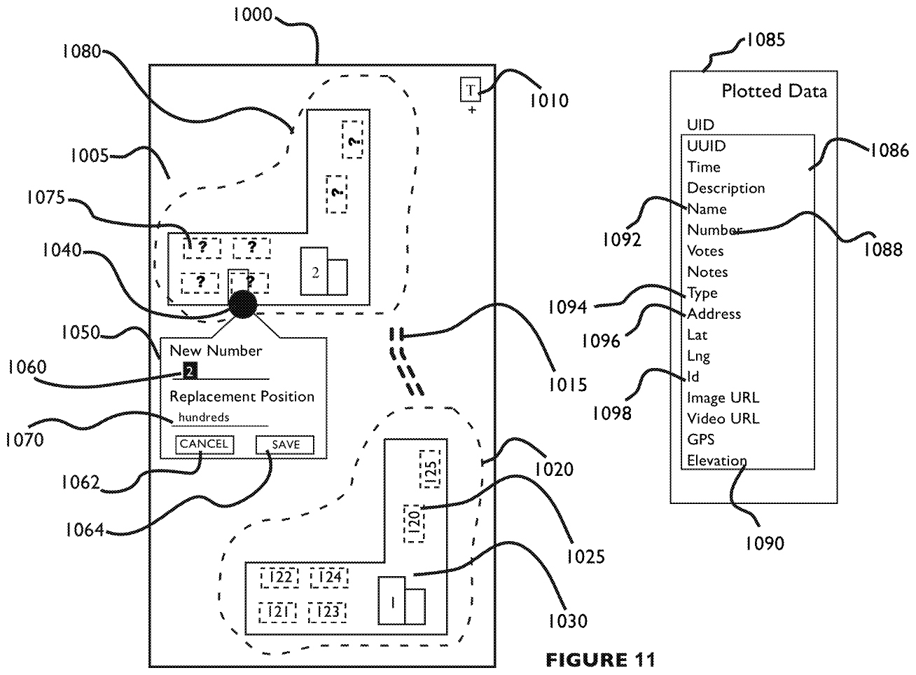

In accordance with embodiments of the invention, FIG. 11 illustrates a simplified diagram of a mobile app navigation like the mobile app navigation 600, with a user interface for a portable electronic device (e.g., a mobile device), tablet, computer, etc. 1000 in a plot editor mode, as indicated by plot editing capability functions 1010. The plot editor mode may provide a GUI (or other user interface) for, among other things, providing graphical displays of position estimates of plots on a GIS layer of maps 1005 of various kinds. In this regard, a user of the portable electronic device 1000 may alter, update, template, clone (or replicate) multiple existing plots—existing locally on the portable electronic device 1000, yet to be sent to or transmitted, stored, or saved on a server like the server 102—by selecting a save button 1064, for example, in a form 1050 having entry fields or the like, that may displayed on the portable electronic device, should the mobile device have the hardware and software available on or to it, or provided by a server like the server 102, for doing this. Multiple plots may be cloned and templated in this manner. A user may use, for example, their finger, a mouse, stylus-type device, other selection tool, or the like to select or grab one or more plots, for example, including a plot 1025 (e.g., a unit door), such as by drawing a ring or shape 1020 around a whole building 1030 and the plots within, that may be cloned (or may be saved as a template for further cloning), where the ring or shape 1020 and the cloned or templated plot(s) within may be dragged, as indicated by 1015, to another location for overlay on a map. Upon releasing their finger, the mouse, stylus, or the other selection tool, as indicated by 1040, the input mechanism 1050, may allow the cloned plots to be altered before saving them locally on the portable electronic device and/or remotely on the server.

These alterations or updates, for example, may replace, for each cloned unit number in the cloned plot(s), certain or all digits that originally numbered the unit(s) in the original plot(s), such as in the hundreds digit (tens digit, thousands digit, etc.) place 1070. The new unit number(s) 1060, with the hundreds digit altered, may replace(s) the(se) existing number(s) that were in the original plot(s) 1025 for all cloned plot(s) 1075 that are or were selected to clone or template 1080 with changed or new the unit numbers.

Based on what is schematically illustrated in FIG. 11 and described above, in accordance with embodiments of the invention, an editor/author or other user may: (1) select multiple plots by drawing a ring or shape around them on the screen of the portable electronic device (or local device); (2) select or click to clone the multiple plots; (3) change unit numbers in the hundreds or tens digits place; (4) drag the cloned or templated plots until they are in a position desired on the map; (5) save them to the portable electronic device; and (5) send or transmit the result to the system server or computer for saving in storage media (or memory) or a database associated with the system server or computer.

The digit replacement position, though set at the hundreds place 1070 in the above example, may be set to other digit places or positions, such as the tens, thousands, ten-thousands, etc. digit places. It should be understood by those skilled in the art, that any of the digit places, including more than one of the digit places, may be changed to a different number. For example, if an existing plot, like the plot 1025, has 3 digits, and during the cloning or templating process, the hundreds digit place is to be replaced by two numbers, then the result may be a new plot number with 4 digits. Specifically, plot numbers 120 and 122 may have the number 88 replace the number 1 in the hundreds digit place to become 8820 and 8822, respectively. As another example, plot numbers 223 and 224 may have the number 7 replace the number 2 in the tens digit place to become 273 and 274, respectively. As a further example, if the editor/author or a user selects plots 101, 102, 103, and 104 on an entire floor of a complex, the hundreds digit (the number “1”) may be changed for all to the number “13,” becoming 1301, 1302, 1303, 1304, respectively.

Referring again to FIG. 11, the right side illustrates what a possible data or information schema 1085 may look like for the plotted data or information and/or the cloned plotted data or information, which may be saved to local storage media (or memory) on a portable electronic device, such as those described above, and/or sent or transmitted by the portable electronic device to the system server or computer for saving on associated storage media and/or database(s). It should be understood by those skilled in the art that some or all of the newly cloned plots 1080 may not be copies of all of the possible cloned plotted data 1085 from, associated with, or within each cloned plot, such as the cloned plot of plot 1025. For example, multiple digits of an original plot number 1088 may be retained in the cloned plot of 1025, an address 1096 may also be retained, as well as an elevation, and a “type” 1094, where type may be a door, building, elevator, or other structure or item of interest for the plots. The plot data, however, such as ID 1098, name 1092, votes, notes, latitude, longitude, image, video, GPS data, etc. typically will not be the same between any plots cloned or not, nor the same between any plots cloned and the original plot.

It should also be understood by those skilled in the art that the cloning and templating, as described above, are merely exemplary and nonlimiting, and there may be other ways to clone or template plots. For example, an editor/author or a user may select multiple plots by tapping, clicking, or otherwise choosing, such as by using their finger, a mouse, stylus, or another selection tool, each plot they want to clone or template in succession. When they are finished selecting the plots, they may drag them collectively to a location on a map and upon releasing their finger, the mouse, stylus, or other selection tool (as was schematically indicated by 1040 in FIG. 11), an input mechanism, such as the input mechanism 1050 discussed above, may allow the user to save 1064 or cancel 1062 the multiple cloned or templated plots locally or send or transmit them to the system server like the server 102 for saving on associated storage media (or memory) or a database.

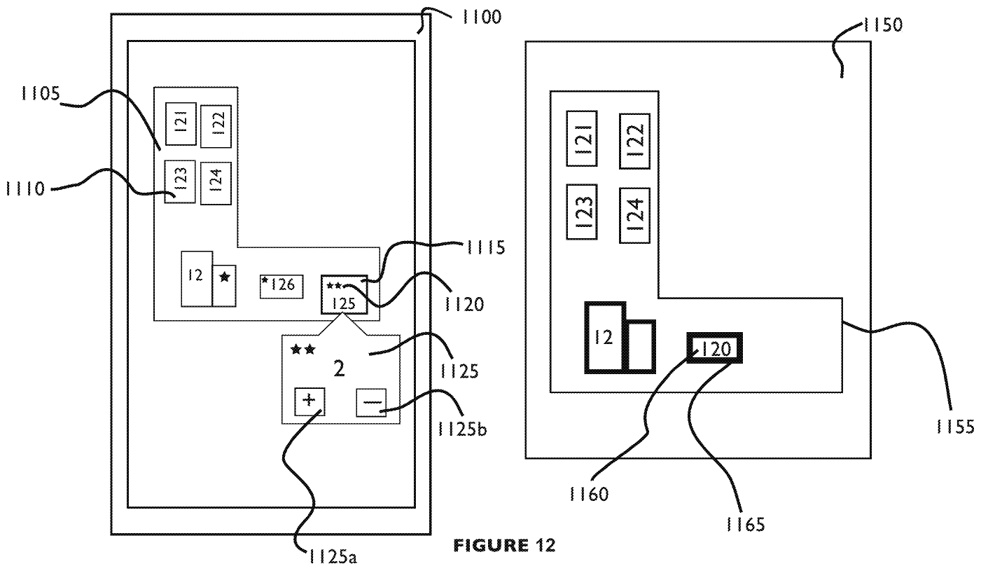

In accordance with embodiments of the invention, FIG. 12 illustrates a simplified diagram of a mobile app navigation like the mobile app navigation 600 with a user interface. The user interface for a portable electronic device (e.g., a mobile device), tablet, or computer 1100 in a plot voting mode or plot voting feature may be opened, as indicated by plot voting capability functions (menu) 1125. An editor/author or user of the portable electronic device 1100 may choose to vote up or down 1125a, 1125b an existing plot 1120 of a building 1105, 1155, a unit door 1160 (shown in a map view 1150 of the portable electronic device 1100) or other property feature, should the portable electronic device 1100 have the hardware and software available on or to it, or provided on a server like the server 102, to do this. Once a plot has been changed, such as voted up or down, an indicator 1120, such as stars or a darker or brighter colored icon (as indicated by 1165), may be shown to the editor/author or user to indicate that the plot has been verified by one or more other authors/editors or other users with a level of certainty (as indicated by 1120). In certain embodiments, the editor/author or user may use their finger, a mouse, a stylus, or another selection tool to select or tap plotted data 1110, 1115 on the screen or display of the portable electronic device or on another associated display to reveal the voting menu 1125, where the user may see a current representation of the vote indicator 1120, which may or may not include a vote numerical total, for that plotted data.

The specific embodiments disclosed herein are merely exemplary, and it should be understood that within the scope of the appended claims, the invention may be practiced in a manner or manners other than those specifically described in these embodiments. Specifically, it should be understood that the claims are not intended to be limited to the particular embodiments or forms disclosed, but rather to cover all modifications, equivalents, and alternatives falling within the spirit and scope of this disclosure. Also, any structures, components, or process parameters, or sequences of steps disclosed and/or illustrated herein are given by way of example only and may be varied as desired. For example, for any steps illustrated and/or described herein that are shown or discussed in a particular order, these steps do not necessarily need to be performed in the order illustrated or discussed. Further, the various exemplary structures, components, or methods described and/or illustrated herein may also omit one or more structures, components, or steps described or illustrated herein or include additional structures, components, or steps in addition to those disclosed.

1. A system for providing navigable environment plots, comprising:
a portable electronic device comprising:
one or more processors;
storage media for storing encoded instructions executable by the one or more processors and for storing a database;
one or more sensors, including an accelerometer, gyroscope, magnetometer, global positioning system (GPS) sensor, altimeter, or barometer;
a display;
wherein the one or more processors execute the instructions to:
determine one or more locations of the portable electronic device,
create a waypoint path, based on one or more outputs of the one or more sensors, to one or more access entries of a particular destination related to the one or more locations as plotted data in the database, and
overlay the waypoint path on a map on the display, the waypoint path being updateable.

2. The system of claim 1, wherein the particular destination comprises a specific building, office, suite, unit, or apartment.

3. The system of claim 1, wherein the one or more access entries includes an identifier used to create other identifiers of other access entries for inclusion in the plotted data or inclusion in other plotted data.

4. The system of claim 1, further comprising one or more other access entries related to the one or more locations, wherein the one or more access entries has one or more identification numbers associated therewith that determine one or more other identification numbers added to the plotted data for the one or more other access entries.

5. A method for providing navigable environment information, comprising:
providing map information for a portable electronic device, the device including one or more processors, media storage, communications circuitry, a display, and one or more sensors, including an accelerometer, gyroscope, magnetometer, global positioning system (GPS) sensor, altimeter, or barometer;
determining a route traveled by the device from a starting location to an ending location based on changing locations of the device;
creating plotted data from the ending location to an access point of one or more specific units of a building by processing one or more outputs from the one or more sensors; and
displaying the plotted data on the display as an overlay on the map information.

6. The method of claim 5, further comprising assigning a building or office number as a clone for creating a new access point or a new building for the plotted data.

7. The method of claim 6, wherein the assigning the building or office number as a clone comprises assigning the building or office number as a clone for numbering other access points in the same building or office for the plotted data.

8. The method of claim 5, further comprising updating the plotted data based on previously or later created plotted data.

9. The method of claim 5, further comprising editing the plotted data to correct previously created plotted data.

10. The method of claim 5, wherein creating the plotted data provides a waypoint path to the one or more specific units of the building.

11. The method of claim 5, wherein creating the plotted data further comprises creating the plotted dating from a parking facility to the access point of the one or more specific units of the building.

12. The method of claim 5, wherein creating the plotted data further comprises creating the plotted dating from a parking facility to the access point that is a loading dock.

13. The method of claim 5, wherein the creating plotted data comprises plotting a building number, unit or suite door number, loading dock, elevation, directions, place(s) of entry to the building, and/or a photo or a video of any of the foregoing.

14. A portable electronic device comprising:
one or more processors;
a sensor comprising at least one of an accelerometer, gyroscope, magnetometer, global positioning system (GPS) sensor, altimeter, or barometer;
computer storage media storing executable instructions that, when executed by the one or more processors, cause the one or more processors to perform operations comprising:
providing map information for the portable electronic device,
determining a route traveled by the device from a starting location to an ending location based on changing locations of the device,
creating plotted data from the ending location to an access point of one or more specific units of a building or office by processing one or more outputs from the sensor, and
displaying the plotted data on the display as an overlay on the map information.

15. The portable electronic device of claim 14, wherein the starting location or the ending location is a store, restaurant, or retail outlet.

16. The portable electronic device of claim 14, wherein the creating plotted data comprises plotting a building number, unit or suite door number, loading dock, elevation, directions, place(s) of entry to the building, and/or a photo or a video of any of the foregoing.

17. The portable electronic device of claim 14, further comprising the computer storage media storing executable instructions that, when executed by the one or more processors, cause the one or more processors to perform operations assigning a building or office number as a clone for creating a new access point or a new building for the plotted data.

18. The portable electronic device of claim 14, further comprising the computer storage media storing executable instructions that, when executed by the one or more processors, cause the one or more processors to perform operations assigning a building or office number as a template for creating a new access point or a new building for the plotted data.

19. Computer-readable storage media storing encoded instructions that, when executed by a processor, perform operations comprising:
providing map information for a portable electronic device, the device including at least one sensor, the at least one sensor including an accelerometer, gyroscope, magnetometer, global positioning system (GPS) sensor, altimeter, or barometer;
determining a route traveled by the device from a starting location to an ending location based on changing locations of the device;
creating plotted data from the ending location to an access point of one or more specific units of a building or office by processing one or more outputs from the one or more sensors; and
overlaying the plotted data on the map information.

20. The computer-readable storage media of claim 19, further comprising storing encoded instructions that, when executed by a processor, perform operations comprising assigning a building or office number as a clone for creating a new access point or a new building for the plotted data.

21. A system for providing navigable environment maps, comprising:
a server comprising:
one or more processors capable of processing sensor data, including accelerometer, gyroscope, magnetometer, global positioning system (GPS), altimeter, or barometer sensor data;
storage media for storing encoded instructions executable by the one or more processors and for storing a database;
Cloud or network communications circuitry;
wherein the one or more processors execute the instructions to:
determine one or more locations for travel to a destination
create plotted data, based on the sensor data, of one or more access points of a building associated with the destination for storage in the database, and
make available for transmission, via the Cloud or network communications circuitry, an overlay of an identifier of the one or more access points of a building for adding to a map of or to the destination.
